(19) United States
(12) Patent Application Publication
(10) Pub. No.: US 2025/0316120 A1
(43) Pub. Date: Oct. 9, 2025

(54) METHOD OF LOCATING A UWB-ENABLED DEVICE

(71) Applicant: NXP B.V., Eindhoven (NL)

(72) Inventors: Srivathsa Masthi Parthasarathi, Bangalore (IN); Sreenivasaiah Hanumapura Venkateshaiah, Ramanagara (IN); Michael Stark, Gleisdorf (AT)

(21) Appl. No.: 19/170,643

(22) Filed: Apr. 4, 2025

(30) Foreign Application Priority Data
Apr. 5, 2024 (IN) 202441028166

(51) Int. Cl. G07C 9/15; G07C 9/00; G07C 9/28

(52) U.S. Cl. CPC G07C 9/15; G07C 9/00309; G07C 9/28; G07C 2009/00793; G07C 2209/63

(57) ABSTRACT

A method of locating a UWB enabled mobile device in a UWB based transit deployment is disclosed. Performed is a data transfer process within a specified proximity between the UWB enabled device and anchors of a transit gate (G1 . . . Gn), wherein multiple distance measurements (RS1 . . . RSn) are performed between the transit gate (G1 . . . Gn) and the UWB enabled device during the data transfer process. Multiple ranging processes or ranging rounds during the data transfer phase are carried out in this way. The multiple ranging processes support improved security as regards data transfer between UWB enabled mobile device and transit gate.

### CROSS-REFERENCE TO RELATED APPLICATIONS

This application claims the priority under 35 U.S.C. § 119 to India Patent application no. 202441028166, filed on Apr. 5, 2024, the contents of which are incorporated by reference herein.

### TECHNICAL FIELD

The present disclosure relates to the technical field of Ultra-wideband (UWB) communication. In particular, the present disclosure relates to a method of locating a UWB-enabled device. Furthermore, the present disclosure relates to a UWB-enabled device. Furthermore, the present disclosure relates to computer implemented methods for carrying out the proposed method.

### BACKGROUND

FiRa® UWB, also known as FiRa Ultra-Wideband, is a high-speed wireless communication technology that operates at very high frequencies, typically between 3.1 GHz and 10.6 GHz. Ultra-Wideband (UWB) technology is characterized by its ability to transmit large amounts of data over short distances, making it ideal for applications such as high-speed data transfer, location tracking, and radar imaging.

FiRa® UWB specifies how data transfer along with ranging can be done and in this case a block alignment between a controller device and a controlee device is done by means of a RCM (ranging control message) transmitted by the controller device. Data payload information elements (IEs) are piggy backed with ranging messages. With this conventional method, there can be only one ranging round in a single phase and a controlee (mobile device) is compelled to perform ranging and data transfer, which can be a problem when a series of control messages/responses (CM/RSP) are to be done during the fare transaction between the transit gate and the mobile device.

U.S. Pat. No. 11,646,758 B2 discloses UWB message transmission method and device, method and device for estimating position on the basis of UWB messages.

US 2021/0289320 A1 discloses localization device and method of operating a localization device.

### SUMMARY

According to a first aspect of the present disclosure there is provided a method of locating a UWB-enabled device, comprising the steps:
performing a data transfer process within a specified proximity between the UWB enabled device and anchors of a transit gate; and
performing multiple distance measurements between the transit gate and the UWB enabled device during the data transfer process.

Multiple ranging processes or ranging rounds during the data transfer phase are carried out in this way. The multiple ranging processes support improved security as regards data transfer between UWB enabled mobile device and transit gate. As a consequence, during the fare transaction, a user carrying the UWB enabled device remains always located also if the data transaction is e.g. appr. 300 ms and the whole transmission scheme is e.g. appr. 400 ms. With the proposed method it is possible to allocate the UWB enabled device very precisely during the fare transaction process.

According to a further aspect, there is provided a UWB based transit gate, comprising means to carry out the proposed method.

According to a further aspect, there is provided a UWB enabled mobile device, comprising means to carry out the proposed method.

According to a further aspect, there is provided a computer implemented method comprising executable instructions which, when executed by a UWB enabled transit gate cause said UWB enabled transit gate to carry out the proposed method.

According to a further aspect, there is provided a computer implemented method comprising executable instructions which, when executed by a UWB enabled device cause said UWB enabled device to carry out the proposed method.

According to one or more embodiments, the multiple distance measurements are performed by means of a double-sided two-way ranging, DS-TWR process.

According to one or more embodiments, wherein data transfer TX slots and data transfer RX slots are used to synchronize the multiple distance measurements.

According to one or more embodiments, a single control message type 1 (CM Type 1) is used to initiate the multiple distance measurements.

According to one or more embodiments, the multiple distance measurements are performed within a data structure having a specified number of data slots.

According to one or more embodiments, the multiple distance measurements are performed within a data structure having a specified duration.

According to one or more embodiments, the UWB enabled device is configured to decide to use at least two of the multiple distance measurements.

According to one or more embodiments, entries in a ranging device management list (RDML) are used to specify addresses of the controller and the controlee of the multiple distance measurements.

According to one or more embodiments, a scheduling scheme of the multiple distance measurements contains at least two distance measurements.

### BRIEF DESCRIPTION OF DRAWINGS

The aspects defined above and further aspects of the present disclosure are apparent from the examples of embodiments to be described hereinafter with reference to the appended drawings, which are explained with reference to the examples of embodiment. However, the disclosure is not limited to the examples of embodiments.

All illustrations in the drawings are schematical. It is noted, that in different figures, similar or identical elements or features are provided with the same reference signs. To avoid unnecessary repetitions, elements or features which have already been elucidated with respect to a previously described embodiment are not elucidated again at a later position of the description.

FIG. 1 shows a scenario of a UWB transit deployment with a user carrying a UWB enabled device;

FIG. 2 shows a conventional data structure used for distance measurements within UWB systems;

FIG. 3 shows a data structure according to an embodiment of the proposed method;

FIG. 4 shows a transmission scheme with eight transit gates of a UWB system, in which the proposed method may be applied;

FIG. 5 shows the data structure of FIG. 3 in more detail and applied to the data structure of FIG. 4;

FIG. 6 shows example entries in a ranging device management list (RDML) of a UWB system;

FIG. 7 shows a principle flow of an embodiment of the proposed method.

FIG. 8 depicts a system including an access control device communicatively coupled to one or more UWB enabled devices.

### DESCRIPTION OF EMBODIMENTS

The FiRa® Consortium specifies a method with data transfer messages (data transfer control messages (DTPCM) and control message type 1 (CM Type 1) for double-sided two-way ranging (DS-TWR) to be combined in one slot, which can facilitate data transfer and DS-TWR between the transit gate and the user mobile device. With said method it is possible to allocate only one DS-TWR ranging round within the phase, which makes the user mobile device sacrifice data transfer slots to DS-TWR, increasing the time to complete a fare transaction (e.g., purchase a ticket).

Embodiments of systems, devices, and methods are described herein that make use of implicit slot locations to realize DS-TWR ranging. Embodiments provide flexibility to the UWB enabled mobile device to participate in ranging rounds belonging to slots where no data transfer is required and the data originated from the UWB enabled mobile device to be used by an access control device as a ranging frame.

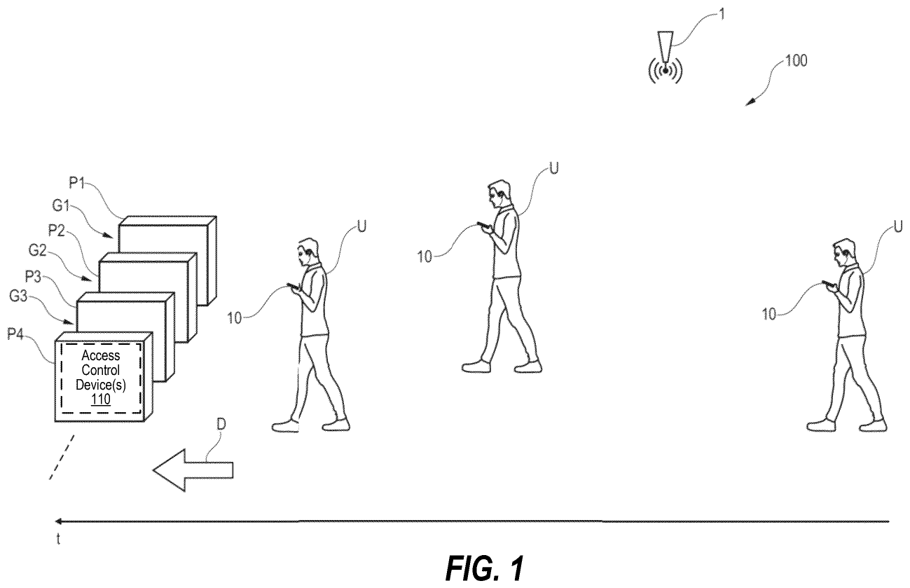

FIG. 1 shows a station entry area of a UWB based transit deployment 100, wherein a Bluetooth® Low Energy beacon device 1 is used to wake up a passenger's UWB enabled device 10 (e.g. mobile device or tag). In one or more embodiments, the UWB enabled device 10 may include a portable computing device, such as a smartphone, a tablet, or another portable computing device. During the time, the passenger U is walking towards transit gates G1 . . . G3, the UWB enabled device 10 performs untracked navigation. In this context, short messages are transmitted by UWB anchors mounted either in the transit gate area or over a wider area in the station. Any UWB enabled device 10 can receive those short messages and use the information contained in them to compute its own position within the station. All of this is accomplished without the need for a UWB enabled device 10 to transmit any UWB message which ensures the privacy of the passenger U, since only the passenger's UWB enabled device 10 knows its own position within the UWB based transit deployment 100.

As shown in FIG. 1, an entry space between two transit gate pillars P1 . . . P4 represents a transit gate G1 . . . G3. The gate pillars P1 . . . P4 are equipped with UWB gate anchors (not shown) with directional antennas facing towards the user U with the UWB enabled mobile device 10. One or more of the UWB gate anchors may be part of or may be coupled to an access control device 110 associated with at least some of the gate pillars P1 . . . P4. In the scenario of FIG. 1 there are four gate anchors (one for each pillar) and three transit gates G1 . . . G3, which correspond to the spaces between the gate pillars P1 . . . P4. Of course, the number four as regards the pillars/anchors is only illustrative in this context. Any number N of gates (G1 . . . GN) may be provided, and the number M of associated gate pillars may be one more than the number of gates (e.g., M=N+1).

In an example, the pillars P1, P2, and P3 may include access control devices 110, which may control a turn style or other barrier to selectively allow a user to pass through the associated gate (G1, G2, or G3). In one or more embodiments, the access control devices 110 may utilize distance measurements to automatically determine a user's commitment to make the payment and, in response to determining the commitment, executes a fare transaction (a fare purchase transaction) and allows the user U to pass through an associated one of the gates (G1, . . . G3).

In the illustrated scenario of FIG. 1, distance measurements are performed during UWB communication sessions between access control devices 110 associated with the transit gates G1, . . . , G3 and the UWB enabled device 10. The UWB communication sessions may be referred to as so called “ranging sessions” or “ranging rounds” or “ranging sets” RS1 . . . RSn. A typical UWB-based ranging session RS1 . . . RSn includes one or more messages (i.e. frames that are part of a distance estimation sequence) transmitted from the access control device 110 (which may also be referred to as a “reader”) to one or more other UWB enabled device 10, as well as one or more messages in response to those frames, which are transmitted by the UWB enabled device 10 back to the access control device 110. It should be appreciated that the access control device 110 may conduct multiple UWB communication sessions (one with each of a plurality of UWB enabled devices 110). Additionally, the access control device 110 of the other pillars may also conduct ranging sessions with the UWB enabled devices 10.

It is noted that, depending on the role assigned to the access control device 110 and the UWB enabled devices in this message exchange, either the access control device 110 may act as an “initiator” or “controller” (in which case the UWB enabled device 10 acts as a “responder” or “controlees”) or the access control device 110 may act as a “responder” or “controlee” (in which case the UWB enabled device 10 may act as an “initiator” or “controller”).

Accordingly, an important application of UWB communication includes performing accurate distance measurements between two transit gates and the UWB enabled device 10 in order to perform localization of the UWB enabled device 10 by means of trilateration. Since modern location-aware devices should support multiple applications at the same time, also multiple distance measurement sessions should be supported at the same time. Implementing a scheduler is a common way of managing the execution of multiple ranging sessions. For instance, a typical scheduler has a task (e.g. a distance measurement session) and its priority as input.

In FIG. 1, the variable t represents time on a timeline and the arrow D indicates a direction of movement of a user U walking toward the transit gates G1 . . . G3. When the user U enters the deployment area, the UWB enabled device 10 may use an out-of-band (OOB) method to wake-up and then participate in the device discovery process via contention-based ranging (CBR) between the access control device 110 and the UWB enabled device 10. The device discovery process is a function executed by the access control device 110 of the transit gate to identify the UWB enabled device 10 of the user U who is potentially close to the transit gate G1 . . . G3 and to infer the intent of the user U to pass through one of the transit gates G1 . . . G3. When the user U is sufficiently close to the transit gate G1 . . . G3, then the access control device 110 determines the user's action as a commitment to make a payment and enter one of the gates, and the access control device 110 corresponding to the selected transit gate executes the fare transaction (data transfer process). Once the proximity estimation based on contention-based ranging (CBR) is completed by the access control device 110, the access control device 110 assigns the user device that is closest to the gate anchor for transit fare transaction. The access control device 110 uses the gate anchor to ensure the proximity of the user during the fare transaction by performing secure DS-TWR with the authenticated UWB enabled user device 10.

It is noted that FIG. 1 only shows an exemplary of a proposed scenario of a UWB based transit deployment 100 (e.g. transit station of a public transport arrangement). In one or more other embodiments, the access control device 110 and the associated pillars P may be installed in various environments for which access is to be controlled. The UWB communication sessions perform a location procedure via distance measurements between specified gate anchors of the transit gates G1 . . . G3 and the UWB enabled device 10 being equipped with a UWB communication unit. For example, the UWB enabled device 10 may be a mobile device that is NFC-enabled (near field communication enabled) and can automatically perform a fare transaction with one of the transit gates G1 . . . G3 without a need to bring the UWB enabled device 10 in contact with the transit gate G1 . . . G3. A pass of the transit gate device suffices to perform the fare transaction. As a result, at the same time, the UWB enabled device 10 may perform localization sessions via distance measurements (trilateration) between itself and three gate anchors of the corresponding gates. Similarly, one or more access control devices 110 may determine distance measurements to the UWB enable device 10 relative to at least three gate anchors to determine the proximity and to authorize the UWB enabled device 10 to pass through a selected one of the gates, such as the gate G1.

In one or more embodiments, the UWB communication sessions are performed as so called “hybrid sessions”, which means that, in relation to the transit gate, two parts of the UWB communication session are carried out. A first part (content access period, contention-based ranging) provides an invitation to all devices in the environment of the gate G1 to take part at the second UWB communication session, which means that the UWB enabled device 10 is invited to answer.

For example, if the UWB enabled device 10 has approached sufficiently close to the transit gate G1 . . . G3, the UWB enabled device 10 is invited to answer. The UWB enabled device 10 then accepts the invitation and communicates with the access control device 110. The second part of the UWB communication session is the transaction between the access control device 110 and the UWB enabled device 10.

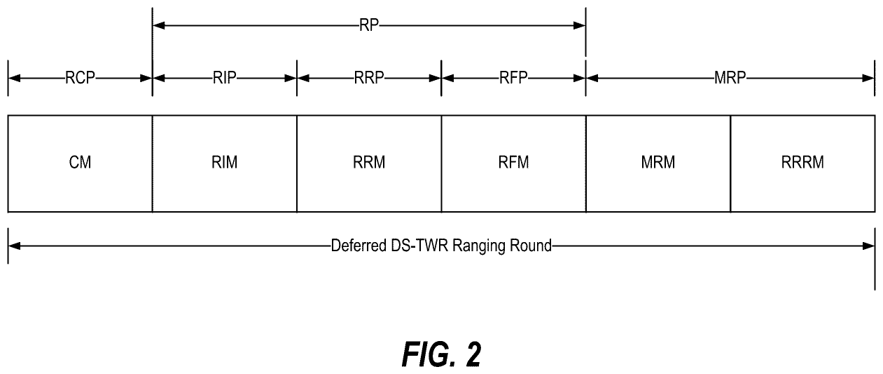

Referring to FIG. 2 now, a typical FiRa-specified DS-TWR ranging round data structure is shown. In a complete ranging round block, there can be multiple of such ranging rounds (distance measurements) RS1 . . . RSn and each ranging round has a control message (CM) transmitted in the first slot. If the ranging round is be realized with data transfer, then the ranging round message includes the CM in the first slot and includes a data message payload (IE). In the FiRa UWB specification, there can be only one ranging round set, which is not adequate. Unlike the conventional UWB specification, embodiments of the present disclosure enable N possible ranging round sets allocated against the data transfer slots and all the ranging sets are bound to one CM transmitted at the beginning of the ranging block.

FIG. 2 shows a conventional data structure of a deferred DS-TWR ranging round. A ranging round control phase (RCP) and a ranging phase (RP) comprises the following different messages: ranging initial message (RIM), ranging response message (RRM) and ranging final message (RFM), followed by a measurement reporting phase (MRP), in which there are different messages as well.

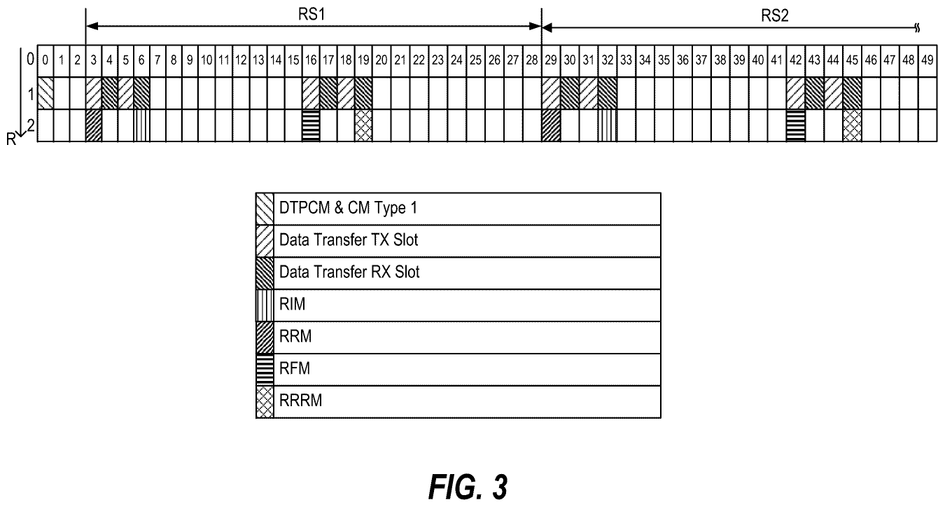

FIG. 3 shows a transmission scheme with two ranging round (distance measurement) sets RS1, RS2, wherein slot #0 represents the control message (CM) type 1 and data transfer phase control message used in FiRa standardized DTPCM protocol and the various hatchings of slots refer to possible non-deferred double sided two way ranging DS-TWR defined in FiRa specification with two-way ranging protocol ranging round sets. The whole sequence of the transmission scheme is initiated by a controller (e.g. the access control device 110), wherein the controlee is represented by the UWB enabled device 10, which looks into the message transmitted by the transit gate G1 . . . Gn and will then participate accordingly to the ranging set. A slot allocation done against the data transfer slots for DS-TWR ranging is specified in the FiRa specification. With this slot allocation method, the media access control (MAC) implementation on the access control device 110 of the transit gate G1 . . . Gn has full control of the assignment of the data transfer for the DS-TWR ranging depending on the data load to complete the transaction.

Similarly, the UWB enabled device 10 (as the controlee device) receives this message and can select the ranging set Rs1 . . . RSn depending on the transaction-related data to be transmitted. It is not necessary to send all those frames, depending on a type of message what exactly is happening in a DS-TWR case, additional frames as regards data frames, RFRAMs and optional data frames (not shown), may be transmitted. In a typical DS-TWR case, the initiator will not order the distance measurement, unless the responder transmits the time-of-flight. Row #0 of the transmission scheme of FIG. 3 shows an index of slots. Row #1 of the scheme of FIG. 3 shows the transmission from the transit gate, row #2 shows what is happening from the transit gate, where the transit gate is allocating all of these slots and the controlee implicitly then participates in any of the ranging sets. This particular slot distribution is representative of how both controller and controlee communicate during the ranging round. It is up to the controlee to determine the ranging set RS1 . . . RSn to which to respond, i.e. the distance measurement is carried out. This could be the case as regards all ranging sets RS1 . . . RSn, however could also be the case to at least two specific ranging set RS1 . . . RSn.

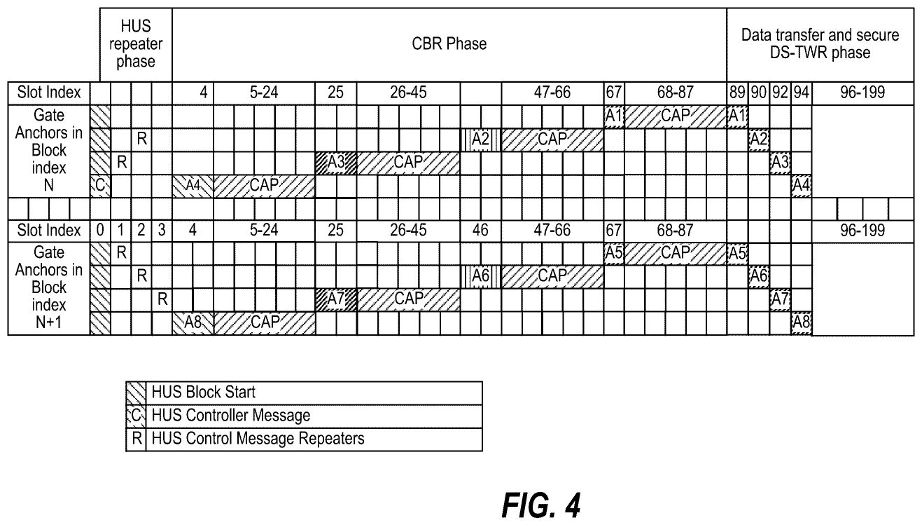

FIG. 4 shows a timing diagram of a communication between transit gate anchors being arranged in two groups (not shown) with an UWB enabled mobile device 10. One recognizes a scheduling of three phases: HUS repeater phase (slots #1 . . . #3), CBR phase (slots #4 . . . #87) and data transfer and secure DS-TWR phase (slots #88 . . . #199). A start of the whole scheduling starts with a control message type 3 (HUS controller message), which is transmitted in slot #0 (HUS Block start) by gate anchor A4 and which is received by all gate anchors by means of repetition processes R in the HUS repeater phase, in which said control message type 3 is transmitted to the remaining gate anchors under usage of gate anchors.

The HUS repeater phase is followed by the contention-based ranging (CBR) phase, wherein in the CBR phase communications with pairs of gate anchors A4/A8, A3/A7, A2/A6 and A1/A5 with the UWB enabled mobile device 10 are performed. Finally, in the data transfer and secure DS-TWR phase, data transactions (e.g. fare transactions and date transmission) are performed between the access control device 110 for a specified gate and the UWB enabled mobile device 10.

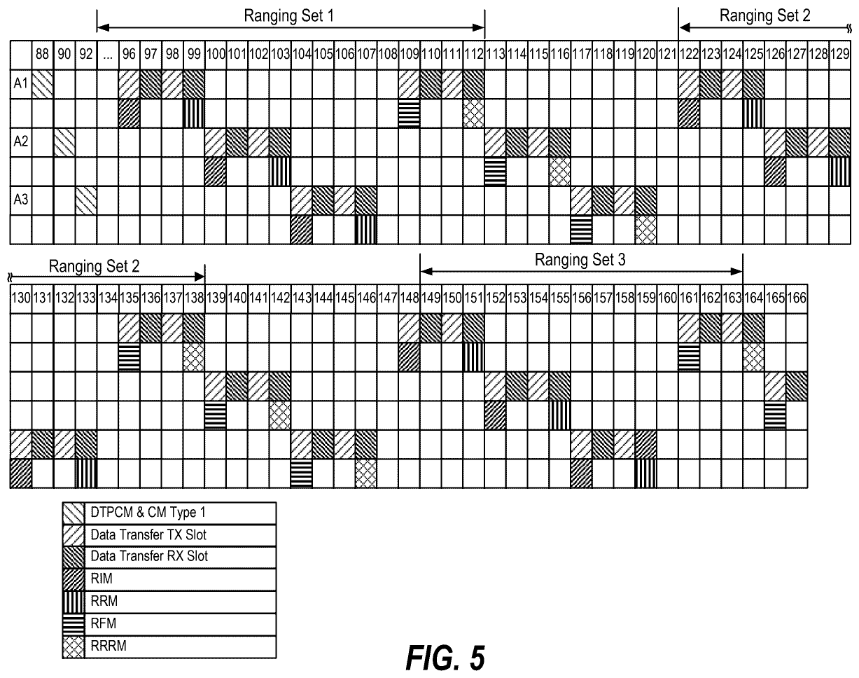

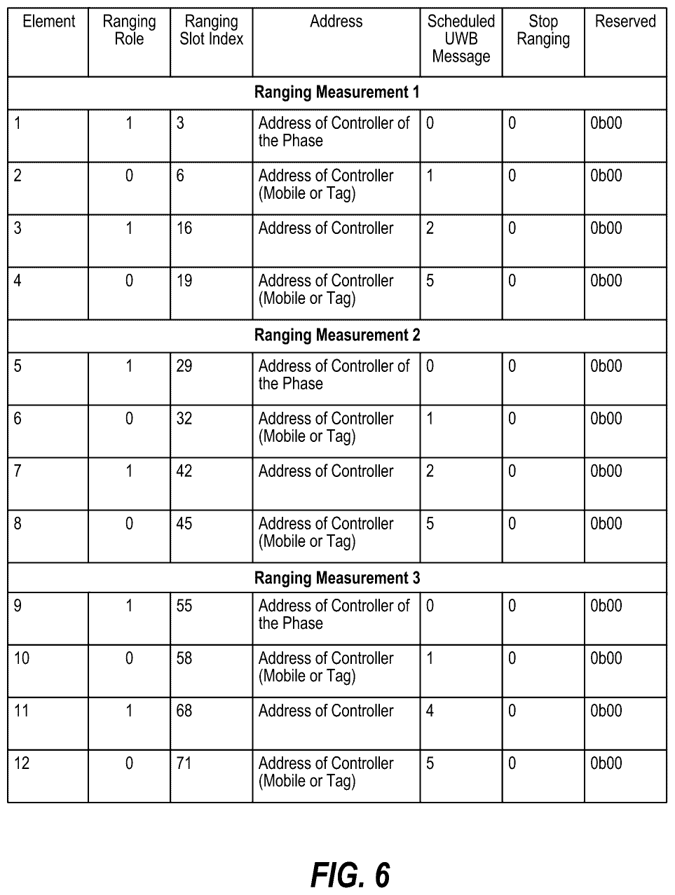

FIG. 5 shows the data transfer phase of the hybrid UWB scheduled (HUS) ranging session according to the transmission scheme of FIG. 3) in more detail with the participation of three transit gates G1 . . . G3 of the scenario of FIG. 1. The access control device 110 of the transit gate anchor acts as the controller of secure DS-TWR processes and assigns possible ranging round sets RS1 . . . RSn. Each ranging round set RS1 . . . RSn is based on non-deferred ranging containing a ranging initiation message (RIM), a ranging response message (RRM), a ranging final message (RFM), and ranging result report message (RRRM) slots. The following rules apply for the gate anchors and associated access control device 110 while performing the DS-TWR processes:
1. The control message (CM) type 1 is sent in the same slot as the DTPCM;
2. The CM type 1 is sent after the DTPCM payload information element (IE);
3. The ranging device management list (RDML) contains the possible ranging round set of the HUS phase (refer to FIG. 6 also for example reference); and
4. It shall allow the controlee device to participate in any of the allowed ranging round sets.

The following rules are applicable for the UWB enabled device 10 (controlee device) (mobile device or tag) participating in the secure DS-TWR ranging rounds:
1. The controlee processes the control messages received in the start slot index of the phase. When the message contains the CM type 1, then it processes the ranging device management list (RDML) and participates in at least one of the ranging round sets. However, the controlee device can participate also in all or more than one ranging round set.

The following requirements are applicable for the controller device (the access control device 110 with the transit gate anchor) and UWB enabled (controlee) device 10 (mobile device or tag) participating in the secure DS-TWR and data transfer in the same slot.
1. The MAC data service data unit (MDSDU) is piggybacked with UWB messages.
2. The MDSDU is carried in dedicated data message payload information elements, which follows the payload information element of the UWB Message.
3. When the data message payload IE is included in the ranging message, it shall be placed after the UWB Message payload IE.
4. If the size of the UWB message and MDSDU exceeds the frame size, then MDSDU shall segment into multiple DM payload IEs and shall send the pending DM payload IEs in next available slots.
5. All MDSDU segments received from the same transmitting device shall be reassembled at the end of the ranging round and forwarded as a MDSDU.
6. The following slot order for scheduling and the corresponding frame type shall be considered while performing non-deferred DS-TWR.

In slots #88, 90, 92 and 94 the above principles are applied in the context of the transmission scheme of FIG. 4. It should be understood that the scheme of FIG. 5 is applied to the scheme of FIG. 4. In effect, the data transfer and secure DS-TWR phases comprising the multiple distance measurements RS1 . . . RSn is carried out with a specified gate having been determined by a trilateration process, which results in a localization of the UWB enabled device 10 by means of multiple distance measurements between two gate anchors and the UWB enabled device 10.

FIG. 6 shows example references for entries in the ranging device management list (RDML). The illustrated example depicts three ranging round sets RS1 . . . RS3 with corresponding slot indexes and addresses of controller (anchor of transit gate) and controlee (UWB enabled device). In effect, each ranging round set RS1 . . . RSn contains at least two distance measurements. Each ranging round set may contain more than two distance measurements. Moreover, a slot duration of the transmission schemes of FIGS. 3 and 5 and a duration of the whole transmission schemes of said figures may be adapted according to requirements.

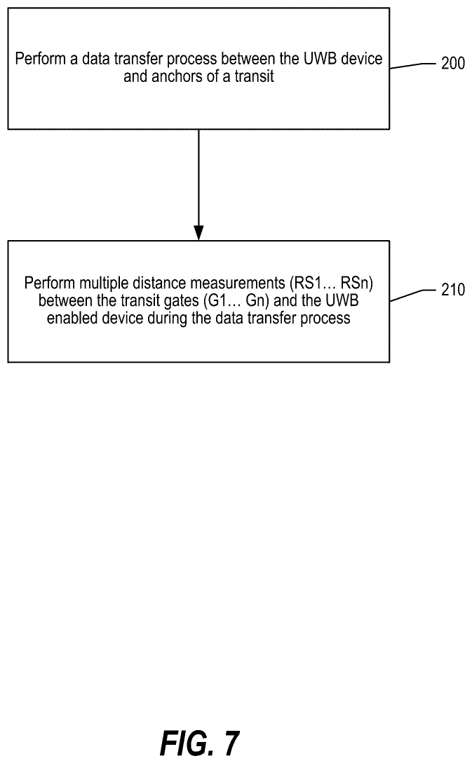

FIG. 7 shows in principle a flow of the proposed method. In a step 200 there is performed a data transfer process within a specified proximity between the UWB enabled device 10 and anchors of a transit gate G1 . . . Gn. In one or more embodiments, the access control device 110 and the UWB enabled device 10 may utilize UWB protocols, as discussed above with respect to FIGS. 1 and 3-5.

In a step 210 there are performed performing multiple distance measurements RS1 . . . RSn between the transit gate G1 . . . Gn and the UWB enabled device (10) during the data transfer process. In one or more embodiments, the access control device 110 may determine a distance between the UWB enabled device 10 of the user U and one of the gates G1, . . . , Gn. Based at least in part on the proximity of the UWB enabled device 10 to the gate, the access control device 110 may communicate with the UWB enabled device 10 to perform a fare transaction.

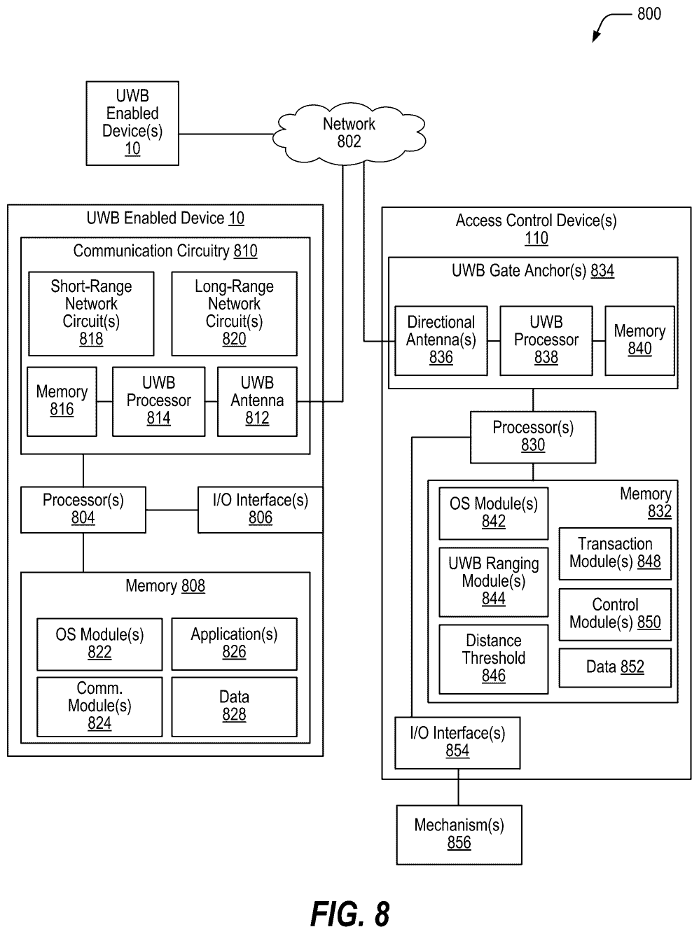

FIG. 8 depicts a system 800 including an access control device 110 communicatively coupled to one or more UWB enabled devices 10. The system 800 may include one or more UWB enabled devices 10 communicatively coupled to one or more access control devices 110 through a communications network 802. It should be appreciated that the communications network may include ultra-wideband communication links between the UWB enabled devices 10 and the one or more access control devices 110.

In one or more embodiments, the UWB enabled devices 10 may include smartphones, tablet computers, other computing devices, or any combination thereof or may include an UWB-enabled tag. An embodiment of a UWB-enabled tag is not shown here, but should be understood to include a UWB antenna coupled to circuitry configured to communicate identifying information to the access control device 110 to enable authentication and authorization for the user U to pass through one of the gates G1 . . . Gn.

The UWB enabled device 10 may be a smartphone or another type of computing device that may include UWB circuitry and that may include other circuitry that is common to smartphones and other computing devices. In an example, the UWB enable device 10 may include one or more processors 804 that may be configured to execute process-readable instructions. In one or more embodiments, the UWB enable device 10 may include one or more processors.

The UWB enabled device 10 may include one or more input/output (I/O) interfaces 806 coupled to the processor 804. The I/O interfaces 806 may include input devices and output devices. The input devices may include a microphone, a touch-sensitive interface, a keypad, a camera, other input devices, or any combination thereof. The output devices may include a display, a speaker, haptic feedback elements, other output devices, or any combination thereof. In one or more embodiments, the I/O interfaces 806 may include one or more ports, such as a universal serial bus (USB) port or another port to couple input devices, output devices, or a combination thereof. In one or more embodiments, the I/O interfaces 806 may include a touchscreen display that may display information (text data, images, video, etc.) and that may receive input data via single or multi-touch or even gestures by the user U.

The UWB enabled device 10 may include a memory 808 coupled to the processor 804 and configured to store processor-readable instructions and to store data. In one or more embodiments, the memory 808 may include one or more non-volatile memory devices. In one or more embodiments, the memory 808 may include a subscriber identity module (SIM) card that may store unique information about the mobile device and the user, such as an International Mobile Subscriber Identity (ISMSI) number that may be used to authenticate a subscriber to a mobile network. The UWB enabled device 810 may include communication circuitry 810 coupled to the processor 804. The UWB enabled device 10 may also include power management circuitry and a rechargeable battery (not shown).

The memory 808 may store one or more operating system (OS) modules 822 that may be executed by the processor 804 to manage the memory 808, components, and processes. The memory 808 may include one or more communication modules 824 that, when executed, cause the processor 804 to receive data from and provide data and instructions to the communication circuitry 810. In one or more embodiments, the communication modules 824 may include UWB communication instructions that, when executed, may cause the processor 804 to control the communication circuitry 810 to participate in UWB ranging operations and to perform a fare transaction with the access control device 110.

The memory 808 may include one or more applications 826 that, when executed, cause the processor 804 to perform one or more operations. In one or more embodiments, the applications 826 may include an Internet browser application, a payment application, a ticketing application, other applications that are common to smartphones or tablet computers, and other software applications with which a user may interact. The memory 808 may store data 828 including user data and application data.

Though not depicted in this example, the UWB enabled device 10 may include global positioning satellite (GPS) circuitry and other circuitry that is common to smartphones, tablet computers, other computing devices, or any combination thereof.

The communication circuitry 810 may include short-range network circuits 818 configured to communicate using Bluetooth, IEEE 802.11x protocols, near field communication (NFC) protocols, or other short-range protocols. The short-range network, circuits 818 may include an antenna for such communications. The communication circuitry 810 may include one or more long-range network circuits 820 configured to communicate with a cellular, digital, or satellite network. The long-range network circuit 820 may include one or more antennas for such communications.

The communication circuitry 810 may include UWB communication circuitry including a UWB processor 814 coupled to a UWB memory 816 and to a UWB antenna 812 that is configured to communicate with the access control device 110 through the network 802. The UWB memory 816 may include a random access memory or a non-volatile memory configured to store information that is received or that is to be sent via the UWB antenna 812. The UWB processor 814 may be configured to control the UWB antenna 812 to receive signals from gate anchors of one or more access control devices 110 and to provide responses according to the UWB ranging operation and, as appropriate, to complete a fare transaction.

In one or more embodiments, the access control device 110 may associated with multiple pillars P (in FIG. 1). In one or more embodiments, each pillar P may include an access control device 110.

In one or more embodiments, the access control device 110 may include one or more processors 830 coupled to a memory 832, which may store processor-executable instructions and data 852. The memory 832 may be a non-volatile memory device. The access control device 110 may include one or more gate anchors 834 coupled to the one or more processors 830. The access control device 110 may include one or more I/O interfaces 854, which may be coupled to one or more gate mechanisms 856. The gate mechanisms 856 may include one or more locks, lockable gates, lockable turnstiles, other gate mechanisms, or any combination thereof.

The UWB gate anchors 834 may include one or more directional antennas 836. Each directional antenna 836 may be configured to transmit data and receive data from a selected direction. The UWB gate anchors 834 may be deployed on one or more pillars forming a gate G or passageway through which a user U and his or her associated UWB enabled device 10 may pass. The UWB gate anchors 834 may include a UWB processor 838 coupled to the one or more directional antennas 836 and a memory 840 coupled to the UWB processor 838. In one or more embodiments, the memory 840 may store data received from or to be transmitted via the directional antennas 836. The memory 840 may also include instructions executable by the UWB processor 838 to encode signals for transmission and to decode received signals to determine proximity of a UWB enabled device 10. In one or more embodiments, the memory 840 may store instructions that, when executed, cause the UWB processor 838 to control the one or more directional antennas 836 to performing ranging operations.

The memory 832 may store one or more OS modules 842 that, when executed, causes the processor 830 to manage all the resources of the access control device 110, including hardware as well as software processes. The memory 832 may include UWB ranging modules 844 that, when executed, cause the processor 830 to provide data and instructions to the UWB gate anchors 834 to trigger performance of ranging operations and to receive range data in response thereto.

The memory 832 may include a distance threshold 846 that may be indicative of an intention of the user U to purchase a fare to pass through one of the gates G. In one or more embodiments, changing range data may indicate movement of the user U toward one of the gates, such as the gate G1. Once the user U has moved within a range corresponding to the distance threshold 846, the UWB ranging module 844 may cause the processor 830 to determine that the user U intends to purchase a fare.

The memory 832 may include one or more transaction modules 848 that, when executed, may cause the processor 830 to communicate with the UWB enabled device 10 to conduct a fare transaction in which the UWB enabled device 10 is charged a fare that is billed to the user U. While conducting the fare transaction, the UWB gate anchors 834 may continue to monitor the proximity of the UWB enabled device by performing secure DS-TWR with the UWB enabled device 10. If fare transaction is successful, the transaction modules 848 may cause the processor 830 to authorize the UWB enabled device 10 to pass through the gate.

The memory 832 may include one or more control modules 850 that, when executed, may cause the processor 830 to communicate control signals to the one or more gate mechanisms 856 via the I/O interfaces 854 to lock or unlock the gate to allow the authorized UWB enabled device 10 to pass through the gate. In one or more embodiments, the UWB gate anchors 834 may continue to monitor the proximity of the UWB enabled device 10 and the control modules 850 may selectively control the gate mechanism 856 to unlock when the changing proximity data corresponds to the user U passing through the gate.

The systems and methods described herein may at least partially be embodied by a computer program or a plurality of computer programs, which may exist in a variety of forms both active and inactive in a single computer system or across multiple computer systems. For example, they may exist as software program(s) comprised of program instructions in source code, object code, executable code or other formats for performing some of the steps. Any of the above may be embodied on a computer readable medium, which may include storage devices and signals, in compressed or uncompressed form.

As used herein, a “computer-readable medium” or “storage medium” may be any means that can contain, store, communicate, propagate, or transport a computer program for use by or in connection with the instruction execution system, apparatus, or device. The computer-readable medium may be, for example but not limited to, an electronic, magnetic, optical, electromagnetic, infrared, or semiconductor system, apparatus, device, or propagation medium. More specific examples (non-exhaustive list) of the computer-readable medium may include the following: an electrical connection having one or more wires, a portable computer diskette, a random-access memory (RAM), a read-only memory (ROM), an erasable programmable read-only memory (EPROM or Flash memory), an optical fiber, a portable compact disc read-only memory (CDROM), a digital versatile disc (DVD), a Blu-ray disc (BD), and a memory card.

Additionally, unless expressly stated to the contrary, the terms “first”, “second”, “third”, etc. are intended to distinguish the particular nouns that modify (e.g. session, device, element, unit, condition, node, module, activity, session, step, operation, etc.). Unless expressly stated to the contrary, the use of these terms is not intended to indicate any type of order, rank, importance, temporal sequence, or hierarchy of the modified noun. For example, “first X” and “second X” are intended to designate two “X” elements that are not necessarily limited by any order, rank, importance, temporal sequence, or hierarchy of the two elements. Furthermore, as referred to herein, “at least one of” and “one or more of” can be represented using the “(s)” nomenclature (e.g. one or more element(s)).

Moreover, it should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

It is noted that the embodiments above have been described with reference to different subject-matters. In particular, some embodiments may have been described with reference to method-type claims whereas other embodiments may have been described with reference to apparatus-type claims. However, a person skilled in the art will gather from the above that, unless otherwise indicated, in addition to any combination of features belonging to one type of subject-matter also any combination of features relating to different subject-matters, in particular a combination of features of the method-type claims and features of the apparatus-type claims, is considered to be disclosed with this document.

Moreover, it is noted that in an effort to provide a concise description of the illustrative embodiments, implementation details which fall into the customary practice of the skilled person may not have been described. It should be appreciated that in the development of any such implementation, as in any engineering or design project, numerous implementation-specific decisions must be made in order to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill.

### REFERENCE NUMERALS

1 downlink TDoA device
10 UWB enabled device
100 UWB based transit deployment
200 . . . 210 method steps
A1 . . . An anchors
D direction
G1 . . . Gn transit gates
P1 . . . Pn pillars
RS1 . . . RSn distance measurement
t time
U user

1. A method of locating an ultra-wideband (UWB) enabled device, comprising the steps:
performing, by an access control device using one or more gate anchors, a ranging process including a plurality of ranging rounds to determine distance measurements between the UWB enabled device and the one or more gate anchors, each ranging round including a plurality of ranging sets, each ranging round including a control message (CM) in a first slot and one or more ranging round sets bound to the CM and allocated to data transfer slots;
performing, by the access control device, a data transfer process when the UWB enabled device is within a specified proximity relative to at least one of the one or more gate anchors of a transit gate;
performing, by the access control device using the one or more gate anchors, multiple distance measurements between the transit gate and the UWB enabled device during the data transfer process; and
upon successful completion of the data transfer process, activating, by the access control device, the transit gate to enable passage of the UWB enabled device.

2. The method according to claim 1, wherein the multiple distance measurements are performed by means of a double sided two-way ranging process.

3. The method according to claim 2, wherein data transfer transmit (TX) slots and data transfer receive (RX) slots of the one or more ranging round sets are used to synchronize the multiple distance measurements.

4. The method according to claim 3, wherein control messages type 1 (CM Type 1) are used to initiate the multiple distance measurements.

5. The method according to claim 1, wherein the multiple distance measurements are performed within a data structure having a specified number of data slots.

6. The method according to claim 5, wherein the multiple distance measurements are performed within a data structure having a specified duration.

7. The method according to claim 1, wherein the UWB enabled device is configured to decide to use at least two of the multiple distance measurements.

8. The method according to claim 1, wherein entries in a ranging device management list (RDML) are used to specify addresses of the access control device and the UWB enabled device of the multiple distance measurements.

9. The method according to claim 1, wherein a scheduling scheme of the multiple distance measurements contains at least two distance measurements.

10. The method according to claim 1, wherein performing the data transfer process comprises completing a fare purchase transaction.

11. A method of locating a UWB enabled device, the method comprising:
performing, by an access control device using one or more gate anchors, a ranging process including a plurality of ranging rounds to determine distance measurements between the UWB enabled device and the one or more gate anchors, each ranging round including a plurality of ranging sets, each ranging round including a control message (CM) in a first slot and one or more ranging round sets bound to the CM and allocated to data transfer slots;
performing, by the access control device, a data transfer process when the UWB enabled device is within a specified proximity relative to at least one of the one or more gate anchors of a transit gate;
performing, by the access control device using the one or more gate anchors, multiple distance measurements between the transit gate and the UWB enabled device during the data transfer process, the multiple distance measurements including a double-sided two way ranging process; and
upon successful completion of the data transfer process, activating, by the access control device, the transit gate to enable passage of the UWB enabled device.

12. The method of claim 11, wherein each ranging round set is based on non-deferred ranging including a ranging initiation message (RIM) slot, a ranging response message (RRM) slot, a ranging final message (RFM) slot, and a ranging result report message (RRRM) slot.

13. The method of claim 11, wherein the access control device is configured to determine the one or more ranging round sets.

14. The method of claim 11, wherein performing the ranging process includes receiving data from the UWB enabled device.

15. The method according to claim 11, wherein data transfer transmit (TX) slots and data transfer receive (RX) slots of the one or more ranging round sets are used to synchronize the multiple distance measurements.

16. The method according to claim 15, wherein control messages type 1 (CM Type 1) are used to initiate the multiple distance measurements.

17. The method according to claim 11, wherein the multiple distance measurements are performed within a data structure having one of a specified number of data slots and a specified duration.

18. A non-transitory storage medium comprising processor-executable instructions that, when executed, cause a processor to perform a method comprising:
performing, by an access control device using one or more gate anchors, a ranging process including a plurality of ranging rounds to determine distance measurements between the UWB enabled device and the one or more gate anchors, each ranging round including a plurality of ranging sets, each ranging round including a control message (CM) in a first slot and one or more ranging round sets bound to the CM and allocated to data transfer slots;
performing, by the access control device, a data transfer process when the UWB enabled device is within a specified proximity relative to at least one of the one or more gate anchors of a transit gate;
performing, by the access control device using the one or more gate anchors, multiple distance measurements between the transit gate and the UWB enabled device during the data transfer process, the multiple distance measurements including a double-sided two way ranging process; and
upon successful completion of the data transfer process, activating, by the access control device, the transit gate to enable passage of the UWB enabled device.

19. The method of claim 18, wherein each ranging round set is based on non-deferred ranging including a ranging initiation message (RIM) slot, a ranging response message (RRM) slot, a ranging final message (RFM) slot, and a ranging result report message (RRRM) slot.

20. The method according to claim 18, wherein the multiple distance measurements are performed within a data structure having one of a specified number of data slots and a specified duration.
